(19) United States
(12) Patent Application Publication
(10) Pub. No.: US 2006/0153419 A1
(43) Pub. Date: Jul. 13, 2006

(54) Device having at least one loudspeaker and at least one coil

(75) Inventor: Erwin Marcel Anna Matthys, De Panne (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindhoven (NL)

(21) Appl. No.: 10/534,483

(22) PCT Filed: Oct. 21, 2003
(86) PCT No.: PCT/IB03/04712

§ 371 Date: May 10, 2005

(30) Foreign Application Priority Data
Nov. 15, 2002 (EP) 02079771.8

(51) Int. Cl. H04R 9/06

(52) U.S. Cl. 381/409; 381/401; 381/400

(57) ABSTRACT

In a device having at least one loudspeaker (21) and one coil (15), the influence of a magnetic field being generated by the loudspeaker (21) on a magnetic field being generated by the coil (15) is decreased without enlarging the distance between the loudspeaker (21) and the coil (15). This is achieved by positioning the loudspeaker (21) with respect to the coil (15) such that a central axis (28) of the loudspeaker (21) and windings (17) of the coil (15) which are closest to the loudspeaker (21) extend substantially in the same plane, wherein, in this plane, the central axis (28) of the loudspeaker (21) extends substantially parallel to these closest windings (17). In this arrangement, lines of force (27) of the magnetic field being generated by the loudspeaker (21) do not cross the larger part of the windings (17) of the coil (15).

The present invention relates to a device comprising at least one loudspeaker and at least one coil.

Well-known examples of such a device are television sets and computer monitors, which generally comprise loudspeakers and a cathode ray tube having a screen, an electrode system and deflection coils. In a colour cathode ray tube, the electrode system has three electron guns for generating three electron beams, which are directed towards an inner surface of the screen. The deflection coils are arranged in order to deflect the electron beams on their way to the screen.

On receipt of a sound signal, the loudspeaker produces an alternating magnetic field. Under the influence of this magnetic field, a deflection coil generates an additional electromagnetic force, which influences the deflection of the electron beams, especially in case of the loudspeaker being a subwoofer operating at a high volume.

The fact that the image being displayed on the screen is adversely affected by bass tones being produced by the subwoofer is unacceptable. Therefore, there is a great need for a solution to the above-sketched problem. An obvious solution, which suggests positioning the subwoofer at a distance from the vertical deflection coil, which is far enough to ensure that the vertical deflection coil will be outside the magnetic field of the subwoofer, is not possible in practice, as the housing of for example a television set or a computer monitor offers limited space.

According to the prior art, several solutions to the above-sketched problem are proposed. Most solutions are aimed at generating a compensating magnetic field, and therefore they require extra components and a relatively complicated arrangement.

JP 60-229585 proposes a solution in which a couple of loudspeakers is provided, the loudspeakers being positioned at opposite sides of a cathode ray tube. The speakers have permanent magnets of different polarities. In such an arrangement, if the loudspeakers are driven by the same sound signal, inverse magnetic fields are generated. These inverse magnetic fields cancel each other, particularly in the centre of the cathode ray tube.

JP 11-285016 proposes a solution in which a compensating coil is provided for producing an inverse magnetic field on the basis of the sound signal. It is a disadvantage of the prior art that additional magnetic components and circuitry are required to compensate the magnetic field of the loudspeakers.

It is an object of the present invention to offer a simple solution to the problem of the image on the screen visibly being disturbed by bass tones. The invention is defined by the independent claims. The dependent claims define advantageous embodiments.

During operation, a subwoofer produces bass tones, i.e. tones in a frequency range of about 25 to 300 Hz. The frequency at which a vertical deflection coil is driven, that is a coil which is responsible for the vertical deflection of the electron beams, and consequently for the vertical building up of an image on the screen, lies within this range. In most cases, the frequency of a bass tone is not exactly the same as the frequency of the vertical deflection coil. For example, the frequency of the vertical deflection coil is 100 Hz, whereas the frequency of a bass tone is 105 Hz. The frequency difference leads to interference, wherein the frequency of this interference is the same as the frequency difference, which in this example is 5 Hz. The interference causes a disturbance of the image on the screen, wherein at certain positions on the screen, the image flickers at the frequency of the interference. In cases in which this frequency is lower than approximately 50 Hz, the human eye is able to observe the flickering. Therefore, in the above example, a user will be able to see the flickering, as it has a frequency of 5 Hz. In general, if the maximum frequency, at which the vertical deflection coil is driven, amounts to 100 Hz, then bass tones up to a frequency of about 150 Hz, result in visible interference, as the frequency difference is less than 50 Hz.

In the device according to the present invention, the position of the loudspeaker with respect to the coil is chosen such as to avoid as much as possible intersection of windings of the coil and lines of force of the magnetic field generated by the loudspeaker. This is advantageous, taking into account the fact that intersection of a conductor and alternating magnetic lines of force leads to generation of an electromagnetic force, wherein the value of this electromagnetic force is highest in case of the conductor extending perpendicular to the lines of force, and lowest or equal to zero in case of the conductor extending parallel to the lines of force. Application of this fact to the case of a device having a coil and a loudspeaker leads to the conclusion that avoiding an intersection of windings of the coil and lines of force of the magnetic field being generated by the loudspeaker results in avoiding a generation of additional electromagnetic forces, which in its turn results in avoiding that the magnetic field generated by the coil is disturbed.

Two important aspects relating to the way in which the avoidance of an intersection of windings of the coil and lines of force of the magnetic field being produced by the loudspeaker takes place in the device according to the present invention, are the shape of the magnetic field and the course of the lines of force, especially in an area close to the coil.

The shape of a magnetic field being produced by a loudspeaker operating at a high volume differs from the shape of a magnetic field being produced by a loudspeaker operating at a low volume. The first-mentioned case is most interesting with regard to the present invention, because only in this case, the produced magnetic field is strong enough to reach the coil and to bring about the generation of additional electromagnetic forces. Research has shown that in the case of high volume, the magnetic field has the shape of a cylinder extending in front of the loudspeaker as well as behind the loudspeaker. The lines of force are linear, and extend substantially parallel to the central axis of the loudspeaker. Only at the ends of the cylinder-shaped magnetic field, the lines of force are curved towards the central axis of the loudspeaker.

On the basis of the above paragraph, it will be clear that in the relevant case of the loudspeaker operating at a high volume, a main part of the magnetic field comprises linear lines of force extending substantially parallel with respect to each other and with respect to the central axis of the loudspeaker.

According to the present invention, the central axis of the loudspeaker and windings of the coil which are closest to the loudspeaker extend substantially in the same plane, wherein, in this plane, the central axis of the loudspeaker extends substantially parallel to the windings of the coil which are closest to the loudspeaker. On the basis of the above, it will be clear that in this arrangement, the lines of force of the magnetic field being produced by the loudspeaker extend substantially parallel to the windings being closest to the loudspeaker, as these lines of force extend substantially parallel to the central axis of the loudspeaker. Therefore, the lines of force do not cross the closest windings.

As tests have proven that application of the present invention leads to far less disturbance of the magnetic field being produced by the coil under the influence of the magnetic field being produced by the loudspeaker, it may be assumed that the lines of force of the latter magnetic field also do not cross further windings. This phenomenon can not be explained by only taking into account the shape of the magnetic field and the normal course of its lines of force. It may therefore be assumed that the lines of force deflect in an area close to the windings. Most likely, the lines of force are transmitted through the core onto which the windings are wound, as this core normally comprises a material having relatively low magnetic resistance.

The present invention will now be explained in greater detail with reference to the figures, in which similar parts are indicated by the same reference signs, and in which:

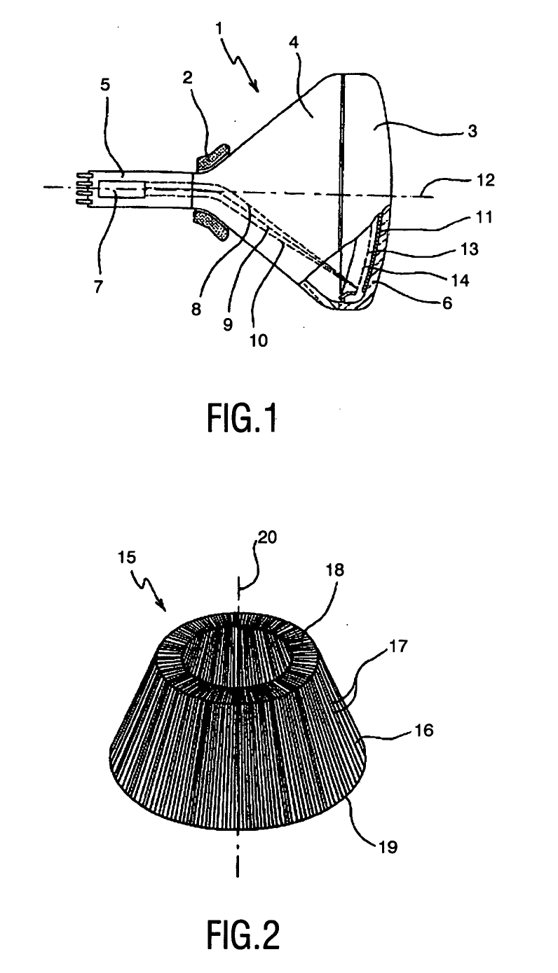

FIG. 1 diagrammatically shows a partial sectional view of a cathode ray tube and deflection coils;

FIG. 2 diagrammatically shows a perspective view of a deflection coil;

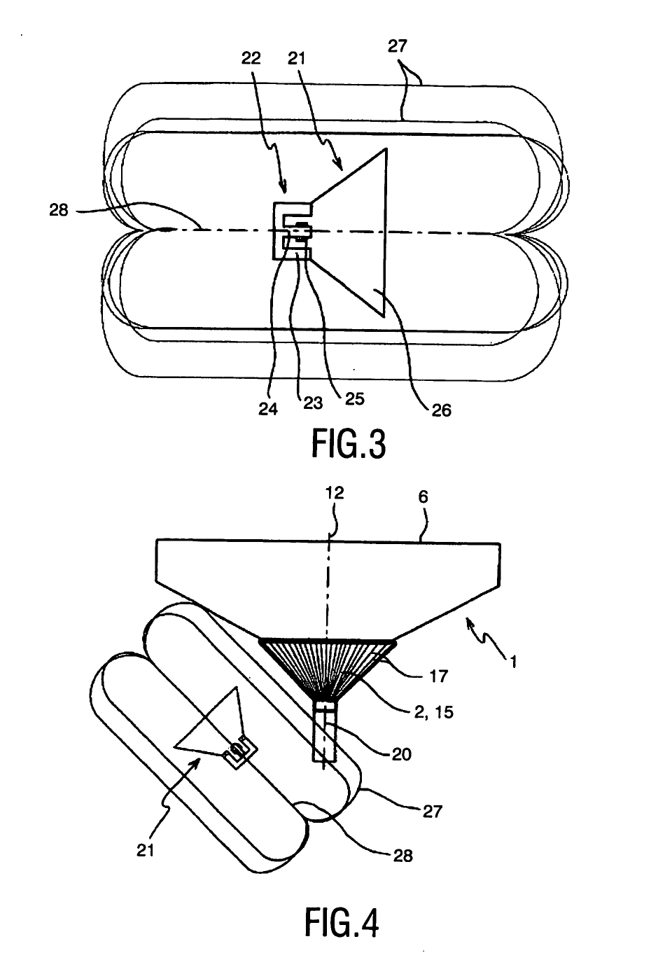

FIG. 3 diagrammatically shows a side view of a loudspeaker and a generated magnetic field; and

FIG. 4 diagrammatically shows a top view of the cathode ray tube, the deflection coils and the loudspeaker being positioned according to the present invention.

Although the present invention will be explained in the context of a television set comprising a cathode ray tube and a loudspeaker, it will be understood that the present invention also relates to other devices comprising at least one loudspeaker and at least one coil like, for example, a computer monitor.

FIG. 1 shows a colour cathode ray tube 1 and deflection coils 2. The cathode ray tube 1 comprises a glass envelope having a panel 3, a cone 4 and a neck 5. The panel 3 comprises a substantially rectangular display window 6 for displaying an image. The neck 5 accommodates an electrode system 7 having three electron guns for generating three electron beams 8, 9, 10. The electron beams 8, 9, 10 are directed towards a display screen 11 which is provided on an inner surface of the display window 6 and which comprises a large number of red, green and blue phosphor elements being laid down in narrow bands. On their way to the display screen 11, the electron beams 8, 9, 10 are deflected by the deflection coils 2 which are coaxially arranged about a central axis 12 of the cathode ray tube 1. Further, the electron beams 8, 9, 10 pass through a shadow mask 13 having apertures 14. The three electron beams 8, 9, 10 pass through the apertures 14 at a small angle with each other and, consequently, they are each incident on phosphor elements of one colour. The image on the display window 6 is constituted by the controlled luminescing of the numerous phosphor elements.

In the following, a vertical direction is defined as the direction in which the phosphor elements on the display screen 11 extend. A horizontal direction is defined as a direction being perpendicular to the vertical direction.

The deflection of the electron beams 8, 9, 10 takes place under the influence of a magnetic field being generated by the deflection coils 2. The deflection coils 2 are positioned as close as possible to the cone 4, at a back portion of the cone 4, as shown in FIG. 1. The deflection coils 2 comprise a horizontal deflection coil (not shown) for the deflection in the horizontal direction as well as a vertical deflection coil 15 (shown in FIG. 2) for the deflection in the vertical direction.

Displaying a moving image requires repeatedly building up of the image on the display window 6. In this process, the repetition frequency should be high enough in order to avoid a user experiencing the image as discontinuous. Usual values for the repetition frequency of the horizontal deflection coil are 15,625 Hz and 32,250 Hz. Usual values for the repetition frequency of the vertical deflection coil 15 are 50 Hz, 60 Hz, 75 Hz, 100 Hz and 120 Hz.

Both the horizontal deflection coil and the vertical deflection coil 15 are wound around a cone-shaped carrier 16, which is diagrammatically shown in FIG. 2. FIG. 2 also diagrammatically depicts the windings 17 of the vertical deflection coil 15. The larger part of each of these vertical windings 17 extends from a back side 18 of the carrier 16 to a front side 19 of the carrier 16, wherein the diameter of the front side 19 is larger than the diameter of the back side 18. The carrier 16 is symmetrical around its central axis 20, and the larger part of each vertical winding 17 extends at the same angle with respect to the central axis 20 of the carrier 16, wherein said larger part extends in a radial plane in which the central axis 20 extends as well. Normally, the vertical windings 17 comprise a ferrite core.

FIG. 3 shows a conventional loudspeaker 21. At a back side, the loudspeaker 21 comprises a permanent magnet 22. A north pole of this permanent magnet 22 is constituted by a cylinder-shaped hollow magnet 23, whereas a south pole of this permanent magnet 22 is constituted by a magnetic bar 24 extending within the hollow magnet 23. Due to the presence of the permanent magnet 22, there is always a magnetic field, regardless whether the loudspeaker 21 does receive a sound signal or does not receive a sound signal. The permanent magnetic field is weak in comparison with magnetic fields which are produced during operation of the loudspeaker 21.

Further, the loudspeaker 21 comprises a speech coil 25, which encompasses the magnetic bar 24. On a back side, the speech coil 25 is attached to a spring (not shown), whereas on a front side, the speech coil 25 is attached to a flexible membrane (not shown). At a front side, the loudspeaker 21 comprises a cone-shaped housing 26 for accommodating said membrane.

During operation of the loudspeaker 21, the speech coil 25 receives a sound signal. On the basis of this sound signal, the speech coil 25 generates an alternating electromagnetic force. The generated forces interact with the permanent forces of the permanent magnet 22. In this process, the speech coil 25 moves under the influence of resulting forces. The movements of the speech coil 25 cause movements of the flexible membrane, whereby air gets displaced. In this way, sound is produced by the loudspeaker 21.

In case of the loudspeaker 21 receiving a relatively strong sound signal, the alternating magnetic field being generated by the speech coil 25 has the shape of a cylinder. The stronger the sound signal, the larger the cylinder-shaped magnetic field. FIG. 3 shows diagrammatically the lines of force 27 of this magnetic field. The cylinder-shaped magnetic field extends beyond the loudspeaker 21, at the front side as well as at the back side thereof. A main part of the lines of force 27 extends parallel to a central axis 28 of the loudspeaker 21. At the ends of the magnetic field, the lines of force 27 are curved towards the central axis 28.

FIG. 4 diagrammatically shows a cathode ray tube 1, deflection coils 2 and a loudspeaker 21, which constitute three elements of a display device, for example, a television set, and which are positioned according to the present invention. FIG. 4 also shows the lines of force 27 of the alternating magnetic field being generated by the loudspeaker 21 during operation.

According to an important aspect of the present invention, the central axis 28 of the loudspeaker 21 and the windings 17 of the vertical deflection coil 15 which are closest to the loudspeaker extend in the same plane. In the shown example, both the central axis 28 of the loudspeaker 21 and these windings 17 extend in a horizontal plane. According to another important aspect of the invention, in said horizontal plane, the central axis 28 of the loudspeaker 21 extends substantially parallel to the vertical windings 17 which are closest to the loudspeaker 21.

In the shown example, each of the windings 17 of the vertical deflection coil 15 extends in a radial plane in which the central axis 20 of the vertical deflection coil 15 extends as well. Consequently, in the arrangement according to the present invention, the central axis 28 of the loudspeaker 21 and the central axis 20 of the deflection coil 15 extend substantially in the same plane. Further, in this plane, an angle between the central axis 20 of the vertical deflection coil 15 and the central axis 28 of the loudspeaker 21 substantially equals the angle between the central axis 20 of the vertical deflection coil 15 and the vertical windings 17.

According to the present invention, the loudspeaker 21 may be positioned above the cathode ray tube 1, under the cathode ray tube 1, at the left side of the cathode ray tube 1, at the right side of the cathode ray tube 1, or at any other possible position with respect to the cathode ray tube 1. At the chosen position, it is important that the central axis 28 of the loudspeaker 21 extends substantially parallel to the vertical windings 17 which are closest to the loudspeaker 21, in all directions.

As the deflection coils 2 are arranged coaxially about the central axis 12 of the cathode ray tube 1, the central axes 12, 20 of the cathode ray tube 1 and the deflection coils 2 coincide with each other. Therefore, in the shown example, the position of the loudspeaker 21 may as well be described as being such that its central axis 28 and the central axis 12 of the cathode ray tube 1 extend in the same plane, and that in this plane, the angle between its central axis 28 and the central axis 12 of the cathode ray tube 1 substantially equals the angle between said central axis 12 of the cathode ray tube 1 and the vertical windings 17 of the vertical deflection coil 15.

In the shown example, the angle between the vertical windings 17 and the central axis 20 of the vertical deflection coil 15 (or the central axis 12 of the cathode ray tube 1) is 45°. Both the central axis 28 of the loudspeaker 21 and the central axis 20 of the vertical deflection coil 15 (or the central axis 12 of the cathode ray tube 1) extend in a horizontal plane. In the horizontal plane, the angle between the central axis 28 of the loudspeaker 21 and the central axis 20 of the vertical deflection coil 15 (or the central axis 12 of the cathode ray tube 1) is 45° as well.

According to the invention, when a loudspeaker 21 is built into a television set comprising a cathode ray tube 1 and deflection coils 2, the loudspeaker 21 is advantageously oriented such that its central axis 28 extends in a radial plane of the deflection coils 2 (or cathode ray tube 1), at an angle with the central axis 20 of the deflection coils 2 (or the central axis 12 of the cathode ray tube 1), which angle substantially equals the angle between the vertical windings 17 of the deflection coils 2 and said central axis 20 of the deflection coils 2 (or the central axis 12 of the cathode ray tube 1).

Preferably, the loudspeaker 21 is oriented such that its front side is at least partly directed towards the front of the television set, whereas its back side is at least partly directed towards the back of the television set.

FIG. 4 clearly shows that the lines of force 27 of the magnetic field being generated by the loudspeaker 21 during operation extend parallel to the central axis 28 of the loudspeaker 21, and that, in the arrangement according to the present invention, these lines of force 27 extend substantially parallel to the closest windings 17 of the vertical deflection coil 15. Such an arrangement is very advantageous in case of the loudspeaker 21 being a subwoofer, which during operation produces bass tones having a frequency which comes close to the repetition frequency of the vertical deflection coil 15.

In a conventional arrangement, the lines of force 27 of a magnetic field being generated by a subwoofer 21 operating at a high volume cross the closest windings 17 of the vertical deflection coil 15. As a result, the vertical deflection coil 15 generates additional electromagnetic forces, which influence the paths of the electron beams 8, 9, 10. The deviation of the paths of the electron beams 8, 9, 10 leads to a disturbance of the image being displayed on the display window 6. The frequency of the disturbance is determined by a difference between the frequency of the tones and the repetition frequency of the vertical deflection coil 15. As the frequency of the tones comes close to the repetition frequency, the frequency of the disturbance is relatively low. In most cases, the frequency of the disturbance is low enough for the human eye to be able to observe the disturbance.

In the arrangement according to the present invention, the lines of force 27 of the magnetic field being produced by the loudspeaker 21 do not cross the windings 17 of the vertical deflection coil 15. Instead, the lines of force 27 extend substantially parallel to the closest windings 17. As tests have proven that on application of the present invention, the image on the display window 6 is not visibly disturbed any more, it is assumed that the lines of force 27 do not cross subsequent windings 17 as well, despite of the fact that the lines of force 27 do not extend parallel to these windings 17. Most likely, the lines of force 27 are further conducted through the ferrite core which is part of the windings 17, so that the lines of force 27 do not come into contact with the windings 17.

It is remarked that the lines of force 27 do cross the windings 17 at the position where the windings 17 make a turn, i.e. at the back side 18 and the front side 19 of the carrier 16. However, this does not lead to a visible disturbance of the image being displayed on the display window 6. The same is true for practical cases in which the path of the windings 17 deviates slightly.

Preferably, in order to ensure an undisturbed image, the loudspeaker 21 is positioned at a distance of at least 10 cm from the deflection coils 2. The larger the distance, the less the influence of the magnetic field being generated by the loudspeaker 21.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact certain measures are recited in mutually different dependent claims does not indicate that combination of these measures cannot be used to advantage.

As already remarked in the foregoing, the present invention does not only apply to television sets, but it applies to any device having a loudspeaker and a coil in which influence of the magnetic field being generated by the loudspeaker on the magnetic field being generated by the coil should be avoided, and in which it is not possible to simply enlarge the distance between the loudspeaker and the coil.

In the foregoing, a device having at least one loudspeaker 21 and one coil 15 is described, wherein the influence of a magnetic field being generated by the loudspeaker 21 during operation on a magnetic field being generated by the coil 15 is decreased without enlarging the distance between the loudspeaker 21 and the coil 15. This is achieved by positioning the loudspeaker 21 with respect to the coil 15 such that a central axis 28 of the loudspeaker 21 and windings 17 of the coil 15 which are closest to the loudspeaker 21 extend substantially in the same plane, wherein, in this plane, the central axis 28 of the loudspeaker 21 extends substantially parallel to the windings 17 of the coil 15 which are closest to the loudspeaker 21. In this arrangement, lines of force 27 of the magnetic field being generated by the loudspeaker 21 do not cross the larger part of the windings 17 of the coil 15.

1. Device comprising at least one loudspeaker and at least one coil, wherein a central axis of the loudspeaker and substantially straight sections of windings of the coil which are closest to the loudspeaker extend substantially in a same plane, and wherein, in this plane, the central axis of the loudspeaker extends substantially parallel to the sections of the windings of the coil which are closest to the loudspeaker.

2. Device according to claim 1, wherein a distance between the coil and the loudspeaker is at least 10 cm.

3. Device according to claim 1, wherein the coil is a vertical deflection coil which is part of a display device comprising a cathode ray tube having at a front side a display window for displaying an image, and at a back side an electrode system for generating electron beams, wherein the vertical deflection coil serves for deflecting the electron beams on their way to an inner surface of the display window in a vertical direction.

4. Device according to claim 3, wherein a front side of the loudspeaker is at least partly directed towards the front side of the display device.

5. Device according to claim 1, wherein the loudspeaker is a subwoofer for producing bass tones in a frequency range of about 25 to 300 Hz.
